(19) United States
(12) Patent Application Publication
(10) Pub. No.: US 2017/0055774 A1
(43) Pub. Date: Mar. 2, 2017

(54) RF DEEP FAT FRYER

(71) Applicant: ILLINOIS TOOL WORKS, INC., Glenview, IL (US)

(72) Inventors: Giorgio Grimaldi, Northbrook, IL (US); Joshua M. Linton, Chicago, IL (US)

(21) Appl. No.: 14/842,236

(22) Filed: Sep. 1, 2015

(51) Int. Cl. A47J 37/12; H05B 6/46

(52) U.S. Cl. CPC A47J 37/1261; H05B 6/46; A47J 37/1266; A23L 1/0107; A23V 2002/00

(57) ABSTRACT

A food preparation device may include a radio frequency (RF) capacitive heating source, a cooking controller operably coupled to the RF capacitive heating source to selectively distribute power to the RF capacitive heating source, and a hot oil basin. The RF capacitive heating source may include a ground plate and an anode plate disposed on opposing sides of the hot oil basin.

### TECHNICAL FIELD

Example embodiments generally relate to food preparation devices and, more particularly, relate to deep fat fryers enabled to cook with radio frequency (RF) capacitive heating energy.

### BACKGROUND

Existing deep fat fryers use hot oil to cook both the interior and exterior of a food product. As a result, food products are exposed to hot oil for enough time to not only crisp the outside of the food but also heat the interior, which increases the amount of grease retained by the food product. Moreover, deep fat fryers inherently present the opportunity for transfer of food particles and impurities during frying time because frying oil is frequently reused. In addition, conventional deep fat fryers are highly consumptive of energy (e.g., natural gas or electricity) in order to maintain the thermostatically-set cooking temperature of the liquid fat reservoir. Conventional deep fat fryers require such a large amount of energy to maintain temperature because they contain a large amount of hot oil in order to compensate for the temperature drop that occurs when food items are submerged in the fryer. Accordingly, it may be desirable to achieve an improved deep fat fryer that minimizes the amount of oil required to cook food and is energy efficient.

### BRIEF SUMMARY OF SOME EXAMPLES

Some example embodiments may provide an RF deep fat fryer. In particular, some example embodiments may provide a food preparation device that provides, for example, rapid cooking of a food product using hot oil to cook the exterior surface of the food product and RF capacitive heat to cook the interior of the food product. In this regard, the food preparation device may provide increased cooking throughput, healthier cooking results, less oil consumption, and more efficient energy use.

In an example embodiment, a food preparation device is provided. A food preparation device may include a radio frequency (RF) capacitive heating source, a cooking controller operably coupled to the RF capacitive heating source to selectively distribute power to the RF capacitive heating source, and a hot oil basin. The RF capacitive heating source may include a ground plate and an anode plate disposed on opposing sides of the hot oil basin.

In another alternative embodiment, a method of preparing food is provided. The method may include inserting a food product having an exterior surface and an interior core into a hot oil basin, heating the food product interior core via an RF capacitive heating source, and crisping the food product external surface via hot oil. The RF capacitive heating source may include a ground plate and an anode plate.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a perspective view of a food preparation device an RF capacitive heating source and hot oil according to an example embodiment;

FIG. 2 illustrates a cross-sectional view of the food preparation device of FIG. 1 according to an example embodiment;

FIG. 3 illustrates a functional block diagram of a food preparation device employing an RF capacitive heating source and hot oil in accordance with an example embodiment;

FIG. 4 illustrates a block diagram of a cooking controller according to an example embodiment; and

FIG. 5 illustrates a block diagram of a method of preparing food including an optional step of sensing a distance between the ground plate and the anode plate via a proximity sensor in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Some example embodiments may improve the cooking performance of a food preparation device and/or may improve the operator experience of individuals employing an example embodiment. In this regard, some example embodiments may provide for the employment of an RF capacitive heating source in addition to hot oil to cook a food product inserted into a hot oil basin.

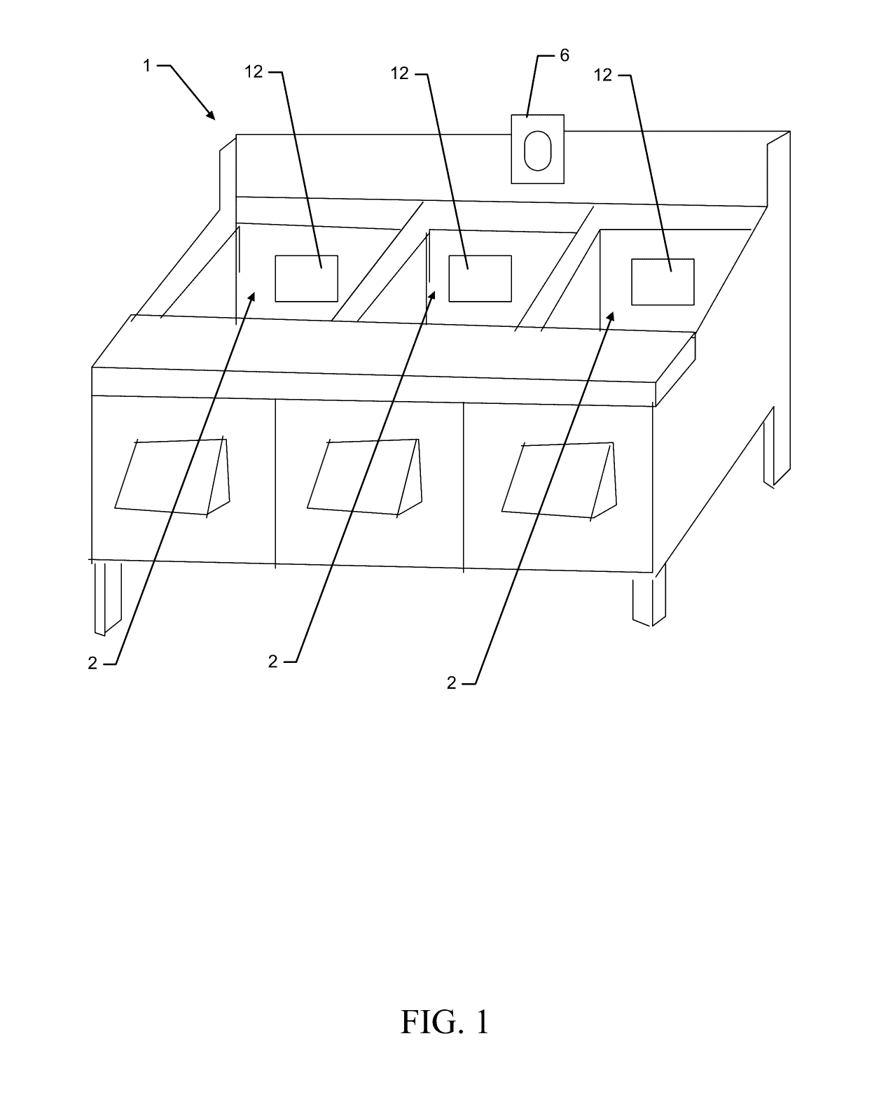

FIG. 1 illustrates a perspective view of a food preparation device 1 according to an example embodiment. The food preparation device 1 may be a deep fat fryer of any type. As shown in FIG. 1, the food preparation device 1 may include a hot oil basin 2 into which a food product may be placed for the application of energy (e.g., RF capacitive heat, hot oil and/or the like). The food preparation device 1 may also include an anode plate 11 and a ground plate 12 positioned within the hot oil basin.

The food preparation device 1 may include an interface panel 6. The interface panel 6 may be the mechanism by which instructions are provided to the operator, and the mechanism by which feedback is provided to the operator regarding cooking process status, options and/or the like. In this regard, the interface panel 6 may be a guided user interface (GUI) that is easily programmed by the user according to unique usage demands of a particular foodservice establishment. In an example embodiment, the interface panel 6 may include a touch screen display capable of providing visual indications to an operator and further capable of receiving touch inputs from the operator. In certain example embodiments, the interface panel 6 may display preprogrammed recipes and cycles from which the operator may select a food preparation program. In other examples, the interface panel 6 may include a simple interface of buttons, lights, dials and/or the like. In further examples, an operator may remotely control the interface panel 6 from a mobile electronic device including, but not limited to, a smartphone, a tablet, a laptop and/or the like.

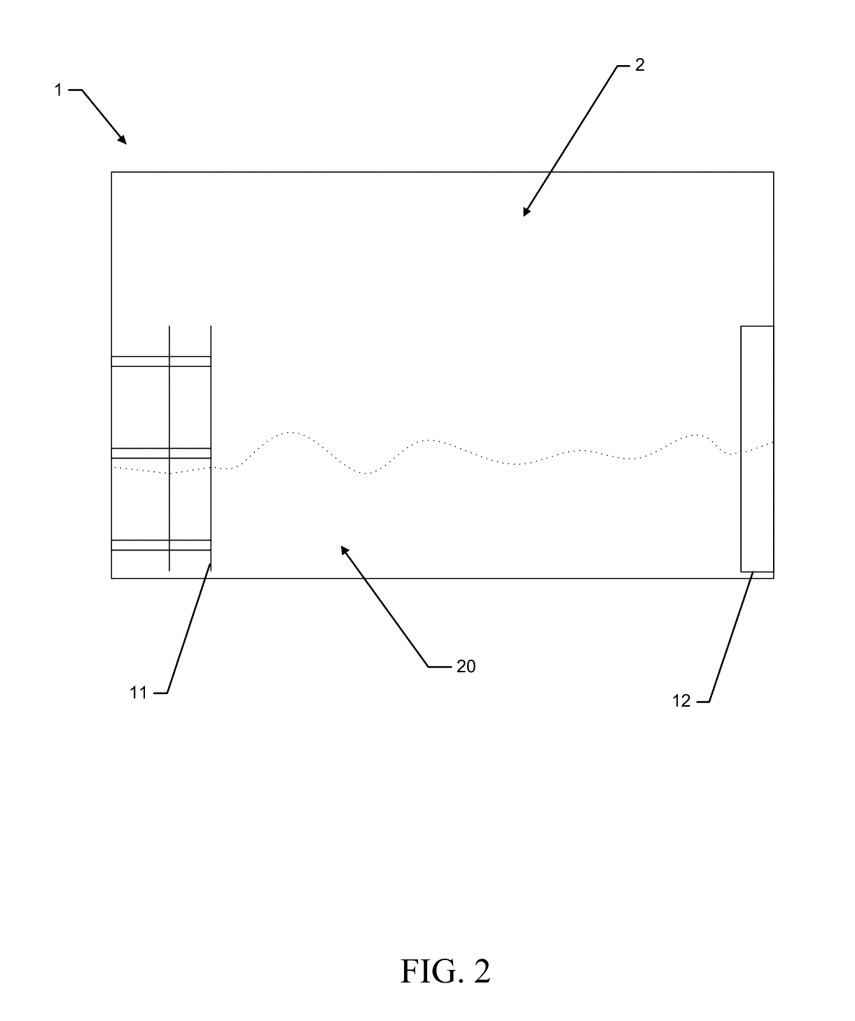

FIG. 2 illustrates a cross-sectional view of the food preparation device of FIG. 1 according to an example embodiment. As shown in FIG. 2, the food preparation device 1 may include hot oil 20 within the hot oil basin 2. In addition, the food preparation device 1 may include an RF capacitive heating source 10 comprising an anode plate 11 and a ground plate 12. However, it should be appreciated that additional energy sources may also be provided in some embodiments, and some embodiments may only employ a single energy source.

As previously mentioned, the RF capacitive heating source 10 may include an anode plate 11 ((i.e. upper electrode) and a ground plate 12 (i.e. lower electrode, cathode plate). Both the anode plate 11 and the ground plate 12 may be flat, horizontal plates situated substantially parallel to each other. In certain embodiments and as shown in FIG. 2, for example, the anode plate 11 and the ground plate 12 may extend in parallel planes that are substantially parallel to side walls of the hot oil basin 2. In other embodiments, however, the anode plate 11 and the ground plate 12 may extend in parallel planes that are substantially perpendicular to the side walls of the hot oil basin 2 such that one of the anode plate 11 and the ground plate 12 may be positioned on the bottom surface of the interior of the hot oil basin 2. In some embodiments, for example, the food preparation device 1 may be a pressure fryer having a sealed lid. In such embodiments, for instance, the remaining one of the anode plate 11 or the ground plate 12 may be positioned on the lid such that the plate 11 or 12 is contained within the hot oil basin 2 when the lid is sealed. In addition, the plate 11 or 12 positioned on the lid may be rotatable out of being perpendicular to the side walls of the hot oil basin 2 when the lid is opened. In further embodiments, for example, the anode plate 11 and the ground plate 12 may extend in parallel planes that are substantially perpendicular to the side walls of the hot oil basin 2 such that one of the anode plate 11 or the ground plate 12 may be positioned on a front wall of the hot oil basin 2 and the other of the anode plate 11 and the ground plate 12 may be positioned on a back wall of the hot oil basin 2. In other example embodiments, the anode plate (i.e. upper electrode) 11 and the ground plate 12 (i.e. lower electrode) may be flexible molded or formed electrodes that envelope or compose a vessel in which the food product is placed during frying and/or cooking. In further example embodiments, the electrodes 11, 12 may be flexible molded or formed electrodes that envelope, line, or compose the hot oil basin 2. Because the anode plate 11 and the ground plate 12 may be positioned in various locations within the hot oil basin 2 in alternative embodiments, in some example embodiments, at least one of the anode plate 11 or the ground plate 12 may be submerged in hot oil 20 during use of the food preparation device 1.

In some embodiments, the RF capacitive heating source transmits RF energy from about 10 MHz to about 50 MHz. For example, RF energy at the 13 MHz, 27 MHz, or 41 MHz frequency may be transmitted from the anode plate 11 to the ground plate 12, although other frequencies in the RF and microwave spectrum are also possible. A food product of any size, shape, mass, or composition may be placed in the hot oil basin 2. After the food product is situated between the anode plate 11 and the ground plate 12 in the hot oil basin 2, a power source (not shown) may be activated that generates an oscillating electromagnetic field at either 13 MHz or 27 MHz or 41 MHz (frequency is based upon the system's particular design). The electrical signal may be provided through an impedance matching device (not shown) to generate the oscillating electromagnetic field between the anode plate 11 and the ground plate 12, through the food product. The oscillating electromagnetic field between the two plates 11, 12 is very uniform as a direct consequence of the food preparation device 1 design and thereby offers much utility to food processing applications where the control of food products' volumetric thermal conditions is of the utmost importance (e.g. cooking applications).

When energy is transmitted from the anode plate 11 through the food product to the ground plate 12, some energy may be absorbed by the food product, some energy may be reflected away from the food product, and some energy may be received by the ground plate 12. As a mass of food product absorbs energy, its thermal conditions and physical properties change (e.g., energy absorption causes the interior core of the food product to cook). As the food product interior core cooks, for example, the impedance properties of the food product within the oscillating electromagnetic field between the anode plate 11 and the ground plate 12 changes and therefore so does the relationship between the power which is absorbed by the food product, reflected, or received into the ground plate 12. This changing relationship may be an ongoing occurrence which transpires continuously during the operation of the food preparation device 1. As the most desirable cooking results are those which are achieved through careful management of the power running through the food preparation device 1, for instance, the impedance matching device (not shown) and its respective electronic control may allow the food preparation device 1 to automatically adjust in real-time to the changing electrical impedance of the food product as it transitions, for example, from raw to cooked. By including both the hot oil and the RF capacitive heating source, for example, hot oil 20 inside the hot oil basin 2 may crisp and/or brown the exterior surface of the food product while the food product interior core is being cooked via the RF capacitive heating source. In this regard, for instance, the food product may be cooked more quickly and with less oil.

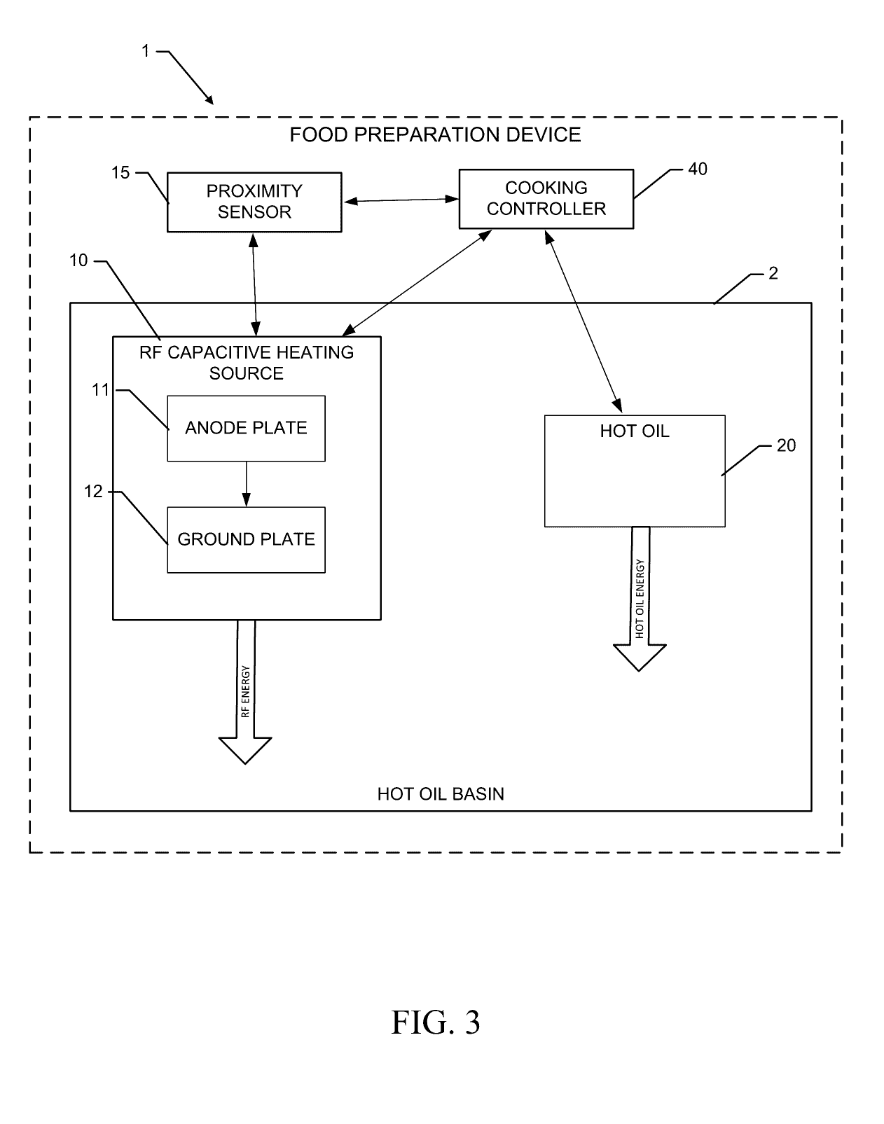

FIG. 3, for example, illustrates a functional block diagram of a food preparation device employing an RF capacitive heating source and hot oil in accordance with an example embodiment. As shown in FIG. 3, the food preparation device 1 may include at least an RF capacitive heating source 10 and hot oil 20 in a hot oil basin 2. In an example embodiment, the RF capacitive heating source 10 may include the anode plate 11 and the ground plate 12 as discussed herein. Both the anode plate 11 and the ground plate 12 may be flat, horizontal plates situated substantially parallel to each other and at least one of the plates may be mobile along an axis (e.g., vertical axis). To take advantage of the fact that the anode plate 11 and the ground plate 12 are mobile, the food preparation device 1 may include an optional proximity sensor 15. The proximity sensor 15, if employed, may be configured to sense the precise physical location of a food product within the hot oil basin 2 and/or a distance between the anode plate 11 and the ground plate 12. By having knowledge of the distance between the anode plate 11 and the ground plate 12 via the proximity sensor 15, it may be possible to automatically mechanically position at least one of the plates via a cooking controller 40 according to settings pre-programmed into the cooking controller 40 without reliance on the operator. Moreover, an operator may select a frying basket size (e.g., small basket, medium basket, large basket, etc.) from the interface panel 6 such that the proximity sensor 15 may determine a desirable distance between the anode plate 11 and the ground plate 12 based on frying basket size and communicate the distance information to the cooking controller 40. In this regard, the cooking controller 40 may automatically mechanically position at least one of the plates in order to ensure a proper distance between the anode plate 11 and the ground plate 12 based on basket size. The proximity sensor 15 may be configured to detect objects in an electric field using an integrated circuit that generates a low-frequency sine wave. The low-frequency sine wave may be adjustable by using an external resistor, optimized for 120 kHz, and may have very low harmonic content to reduce harmonic interference. The proximity sensor 15 may also include support circuits for a microcontroller unit to allow the construction of a two-chip E-field system. In this regard, the proximity sensor 15 (and its associated software functionality) may eliminate the need for an operator to engage in the accurate or precise positioning of the anode plate 11 and/or the ground plate 12 relative to the shape, size, and/or physical location of the food product by automating such functionality.

In an example embodiment, the RF capacitive heating source 10 may be employed to cook the interior core of the food product while the exterior surface of the food product cooks simultaneously via the hot oil 20. However, it should be appreciated that additional energy sources may also be provided in some embodiments and, as stated above, some embodiments may only employ a single energy source. Either simultaneously with the application of RF capacitive heat energy, before the application of RF capacitive heat energy, or after the application of RF capacitive heat energy, the hot oil may apply heat to the exterior surface of the food product in order to cook the exterior surface by, for example, browning, crisping and/or the like.

In an example embodiment, the RF capacitive heating source 10 may be controlled, either directly or indirectly, by the cooking controller 40. In this regard, the cooking controller 40 may simultaneously apply RF energy from the RF capacitive heating source 10 while the food product is disposed in the hot oil basin 2. Moreover, it should be appreciated that the RF capacitive heating source 10 may be operated responsive to settings or control inputs that may be provided at the beginning, during or at the end of a program cooking cycle. Furthermore, energy delivered via the RF capacitive heating source 10 may be displayable via operation of the cooking controller 40. The cooking controller 40 may be configured to receive inputs descriptive of the food product and/or cooking conditions in order to provide instructions or controls to the RF capacitive heating source 10 to control the cooking process. Moreover, the cooking controller 40 may be configured to provide at least two timing functions. In this regard, a first timing function may define a submergence time for the food product in the hot oil 20 in the hot oil basin 2, while a second timing function may define an RF energy application time for applying the RF energy to the food product. In some example embodiments, the RF energy application time may be less than the submergence time.

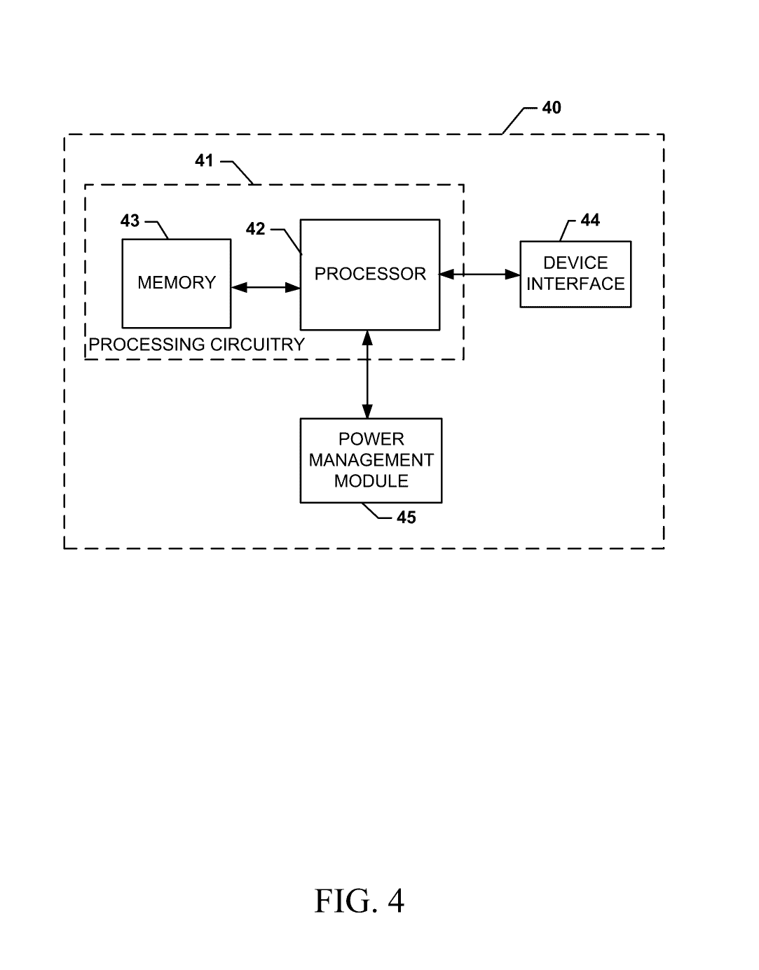

In an example embodiment, the cooking controller 40 may be any means such as a device or circuitry embodied in either hardware, or a combination of hardware and software that is configured to execute (or provide instructions for execution of) a strategic control over power distribution to the at least two energy sources. In this regard, the cooking controller 40 is configured to control volumetric thermal conditions of a food product having an interior core and an exterior surface. In some embodiments, the cooking controller 40 may monitor at least one of humidity, temperature, time, or any combination thereof. FIG. 4 illustrates a block diagram of the cooking controller 40 in accordance with an example embodiment. In this regard, as shown in FIG. 4, the cooking controller 40 may include processing circuitry 41 that may be configured to interface with, control or otherwise coordinate the operations of various components or modules described herein in connection with controlling power distribution to the at least two energy sources as described herein. The cooking controller 40 may utilize the processing circuitry 41 to provide electronic control inputs to one or more functional units of the cooking controller 40 to receive, transmit and/or process data associated with the one or more functional units and perform communications necessary to enable performance of an operator-selected food preparation program as described herein.

In some embodiments, the processing circuitry 41 may be embodied as a chip or chip set. In other words, the processing circuitry 41 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry 41 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 41 may include one or more instances of a processor 42 and memory 43 that may be in communication with or otherwise control a device interface 44. As such, the processing circuitry 41 may be embodied as a circuit chip (e.g., an integrated circuit chip) configured (e.g., with hardware, software or a combination of hardware and software) to perform operations described herein.

The device interface 44 may include one or more interface mechanisms for enabling communication with other components or devices (e.g., the interface panel 6). In some cases, the device interface 44 may be any means such as a device or circuitry embodied in either hardware, or a combination of hardware and software that is configured to receive and/or transmit data from/to devices or components in communication with the processing circuitry 41 via internal and/or external communication mechanisms. Accordingly, for example, the device interface 44 may further include wired and/or wireless communication equipment for at least communicating with the at least two energy sources, and/or other components or modules described herein.

The processor 42 may be embodied in a number of different ways. For example, the processor 42 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 42 may be configured to execute instructions stored in the memory 43 or otherwise accessible to the processor 42. As such, whether configured by hardware or by a combination of hardware and software, the processor 42 may represent an entity (e.g., physically embodied in circuitry—in the form of processing circuitry 41) capable of performing operations according to embodiments of the present invention while configured accordingly. Thus, for example, when the processor 42 is embodied as an ASIC, FPGA or the like, the processor 42 may be specifically configured hardware for conducting the operations described herein. Alternatively, as another example, when the processor 42 is embodied as an executor of software instructions, the instructions may specifically configure the processor 42 to perform the operations described herein in reference to execution of an example embodiment.

In an exemplary embodiment, the memory 43 may include one or more non-transitory memory devices such as, for example, volatile and/or non-volatile memory that may be either fixed or removable. The memory 43 may be configured to store information, data, applications, instructions or the like for enabling the processing circuitry 41 to carry out various functions in accordance with exemplary embodiments of the present invention. For example, the memory 43 may be configured to buffer input data for processing by the processor 42. Additionally or alternatively, the memory 43 may be configured to store instructions for execution by the processor 42. As yet another alternative or additional capability, the memory 43 may include one or more databases that may store a variety of data sets or tables useful for operation of the modules described below and/or the processing circuitry 41. Among the contents of the memory 43, applications or instruction sets may be stored for execution by the processor 42 in order to carry out the functionality associated with each respective application or instruction set. In some cases, the applications/instruction sets may include instructions for carrying out some or all of the operations described in reference to algorithms or flow charts for directing control over power distribution and/or various components of the food preparation device 1 as described herein. In particular, the memory 43 may store executable instructions that enable the computational power of the processing circuitry 41 to be employed to improve the functioning of the cooking controller 40 relative to the control over the at least two energy sources as described herein. As such, the improved operation of the computational components of the cooking controller 40 transforms the cooking controller 40 into a more capable power distribution control device relative to the at least two energy sources and/or food preparation device 1 associated with executing example embodiments.

As shown in FIG. 4, the cooking controller 40 may further include (or otherwise be operably coupled to) a power management module 45. In some examples, the processor 42 (or the processing circuitry 41) may be embodied as, include or otherwise control various modules (e.g., the power management module 45) that are configured to perform respective different tasks associated with the cooking controller 40. As such, in some embodiments, the processor 42 (or the processing circuitry 41) may be said to cause each of the operations described in connection with the power management module 45 as described herein.

The power management module 45 may be any means such as a device or circuitry embodied in either hardware, or a combination of hardware and software that is configured to execute control over the distribution of power to the RF capacitive heating source 10. In this regard, the power management module 45 may be configured to receive cooking information (e.g., from a user via the interface panel 6) regarding the food product or a cooking mode or program to be executed. Based on the cooking information provided, the power management module 45 may select a power distribution algorithm from among a plurality of stored power distribution algorithms. The selected power distribution algorithm may then be executed to provide power to the desired energy sources at desirable times, power levels, sequences and/or the like.

In an example embodiment, the power management module 45 may include a plurality of stored algorithms, each of which defines a corresponding pattern (e.g., predetermined or random) for power distribution to the RF capacitive heating source 10. In some cases, the stored algorithms may be associated with corresponding different cooking programs, cooking modes, or such algorithms may be named and selectable by the user from a menu. Regardless of how selected, once the power management module 45 selects an algorithm, the selected power distribution algorithm may be executed by the processing circuitry 41, which ultimately provides for control inputs to be provided to the RF capacitive heating source 10.

In some embodiments, the cooking controller 40 (and/or the power management module 45) may be configured to receive static and/or dynamic inputs regarding the food product and/or cooking conditions. Dynamic inputs may include feedback data regarding absorption of RF spectrum, as described above. In some cases, dynamic inputs may include adjustments made by the operator during the cooking process. The static inputs may include parameters that are input by the operator as initial conditions. For example, the static inputs may include a description of the food type, initial state or temperature, final desired state or temperature, a number and/or size of portions to be cooked, a location of the item to be cooked (e.g., when multiple trays or levels are employed), and/or the like.

In another aspect, a method of preparing food is provided. The method may include inserting a food product having an exterior surface and an interior core into a hot oil basin, heating the food product interior core via an RF capacitive heating source, and crisping the food product external surface via hot oil. The RF capacitive heating source may include a ground plate and an anode plate. In some embodiments, for example, the RF capacitive heating source may transmit RF energy from about 10 MHz to about 50 MHz. According to certain embodiments, for example, at least one of the ground plate or the anode plate may be mobile. In some embodiments, for instance, the method may further comprise sensing a distance between the ground plate and the anode plate via a proximity sensor. In further embodiments, for example, at least one of the ground plate or the anode plate may be submerged in hot oil during use. According to certain example embodiments, heating the food product interior core via the RF capacitive heating source may comprise applying RF energy from the RF capacitive heating source to the food product via a cooking controller while the food product is disposed in the hot oil basin. In some embodiments, for example, the cooking controller is configured to provide at least two timing functions. In such embodiments, for instance, the first timing function may define a submergence time for the food product in the hot oil basin, and the second timing function may define an RF energy application time for applying the RF energy to the food product. In certain embodiments, for instance, the RF energy application time may be less than the submergence time.

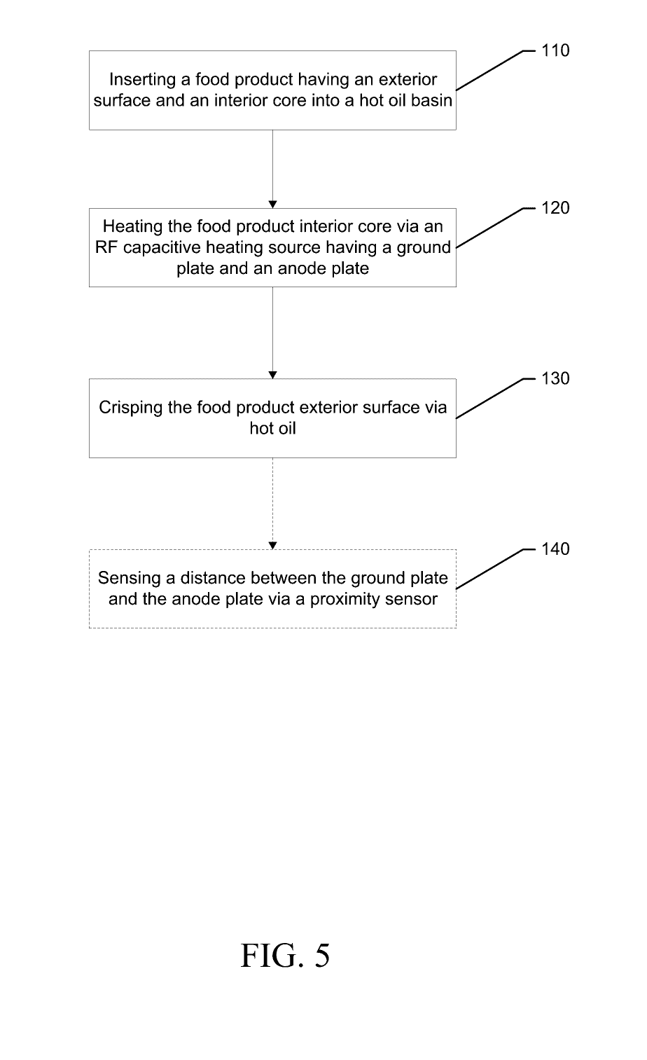

FIG. 5, for example, illustrates a block diagram of a method of preparing food including an optional step of sensing a distance between the ground plate and the anode plate via a proximity sensor in accordance with an example embodiment. As shown in FIG. 5, the method includes inserting a food product having an exterior surface and an interior core into a hot oil basin at operation 110, heating the food product interior core via an RF capacitive heating source at operation 120, and crisping the food product external surface via hot oil at operation 130. In addition, the method may include an optional step of sensing a distance between the ground plate and the anode plate via a proximity sensor at operation 140. Although operation 120 is shown as occurring prior to operation 130 in FIG. 5, it should be understood that operations 120 and 130 may also occur simultaneously, or operation 130 may occur prior to operation 120.

Example embodiments may provide a food preparation device capable of providing rapid cooking of a food product using hot oil to cook the exterior surface of the food product and RF capacitive heat to cook the interior of the food product. In this regard, the food preparation device may provide increased cooking throughput, healthier cooking results, less oil consumption, and more efficient energy use.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A food preparation device, comprising:
a radio frequency (RF) capacitive heating source;
a cooking controller operably coupled to the RF capacitive heating source to selectively distribute power to the RF capacitive heating source; and
a hot oil basin,
wherein the RF capacitive heating source comprises a ground plate and an anode plate disposed on opposing sides of the hot oil basin.

2. The food preparation device of claim 1, wherein RF energy is transmitted from the anode plate to the ground plate to form an electromagnetic field between the anode plate and the ground plate in the hot oil basin.

3. The food preparation device of claim 1, wherein at least one of the ground plate or the anode plate is submerged in hot oil during use.

4. The food preparation device of claim 1, wherein at least one of the ground plate or the anode plate is mobile.

5. The food preparation device of claim 4, further comprising a proximity sensor to sense a distance between the ground plate and the anode plate.

6. The food preparation of device of claim 1, wherein the RF source transmits RF energy from about 10 MHz to about 50 MHz.

7. The food preparation device of claim 1, wherein the anode plate and the ground plate extend in parallel planes that are substantially parallel to side walls of the hot oil basin.

8. The food preparation device of claim 1, wherein the anode plate and the ground plate extend in parallel planes that are substantially perpendicular to the side walls of the hot oil basin.

9. The food preparation device of claim 8, wherein one of the anode plate or the ground plate is rotatable out of being perpendicular to the side walls of the hot oil basin.

10. The food preparation device of claim 1, wherein the cooking controller simultaneously applies RF energy from the RF capacitive heating source while a food product is disposed in the hot oil basin.

11. The food preparation device of claim 10, wherein the cooking controller is configured to provide at least two timing functions, and wherein a first timing function defines a submergence time for the food product in the hot oil basin, and a second timing function defines an RF energy application time for applying the RF energy to the food product.

12. The food preparation device of claim 11, wherein the RF energy application time is less than the submergence time.

13. A method of preparing food, comprising:
inserting a food product having an exterior surface and an interior core into a hot oil basin;
heating the food product interior core via a radio frequency (RF) capacitive heating source; and
crisping the food product exterior surface via hot oil,
wherein the RF capacitive heating source comprises a ground plate and an anode plate.

14. The method of claim 13, wherein at least one of the ground plate or the anode plate is mobile.

15. The method of claim 13, further comprising sensing a distance between the ground plate and the anode plate via a proximity sensor.

16. The method of claim 13, wherein at least one of the ground plate or the anode plate is submerged in hot oil during use.

17. The method of claim 13, wherein the RF capacitive heating source transmits RF energy from about 10 MHz to about 50 MHz.

18. The method of claim 13, wherein heating the food product interior core via the RF capacitive heating source comprises simultaneously applying RF energy from the RF capacitive heating source to the food product via a cooking controller while the food product is disposed in the hot oil basin.

19. The method of claim 18, wherein the cooking controller is configured to provide at least two timing functions, and wherein a first timing function defines a submergence time for the food product in the hot oil basin, and a second timing function defines an RF energy application time for applying the RF energy to the food product.

20. The method of claim 19, wherein the RF energy application time is less than the submergence time.
